(19) United States
(12) Patent Application Publication
(10) Pub. No.: US 2017/0219885 A1
(43) Pub. Date: Aug. 3, 2017

(54) BACKLIGHT DEVICE AND LIQUID CRYSTAL DISPLAY DEVICE PROVIDED WITH SAME

(71) Applicant: SHARP KABUSHIKI KAISHA, Sakai City, Osaka (JP)

(72) Inventors: Atsuyuki TANAKA, Sakai City (JP); Naoto INOUE, Sakai City (JP)

(73) Assignee: Sharp Kabushiki Kaisha, Sakai City, Osaka (JP)

(21) Appl. No.: 15/308,442

(22) PCT Filed: Mar. 26, 2015
(86) PCT No.: PCT/JP2015/059316

§ 371 Date: Nov. 2, 2016

(30) Foreign Application Priority Data
May 14, 2014 (JP) 2014-100602

(51) Int. Cl. G02F 1/1335; H05B 33/08

(52) U.S. Cl. CPC G02F 1/133609; G02F 1/133621; G02F 1/133603; H05B 33/0857

(57) ABSTRACT

Provided is a backlight device for a liquid crystal display device, which is capable of suitably adjusting a white point and realizing a wide color reproduction range.

An LED module that is a light source of the backlight device is constituted by a magenta light emitting body (110) having a structure in which a blue LED element (112) is covered with a red phosphor (114), a green light emitting body (120) including a green LED element (122), and a red light emitting body (130) including a red LED element (132). A backlight driving circuit independently controls each of luminance of light emitted from the magenta light emitting body (110), luminance of light emitted from the green light emitting body (120), and luminance of light emitted from the red light emitting body (130).

### TECHNICAL FIELD

The present invention relates to a backlight device, and, more specifically, relates to a backlight device for a liquid crystal display device which uses LEDs (light emitting diodes) as a light source.

### BACKGROUND ART

Recently, as digital equipment has notably higher functionality and higher performance, demands for higher quality regarding various images have been increased. Then, in a field of a display device, a printing device, an imaging device, or the like, expansion of a color reproduction range (also referred to as “color gamut”) has been aimed conventionally. As to a liquid crystal display device such as a liquid crystal television, expansion of a color reproduction range is aimed by, for example, improving a backlight device or a color filter.

By the way, a color is displayed by additive color mixture of three primary colors in the liquid crystal display device. Accordingly, a liquid crystal display device of a transmission type requires a backlight device capable of radiating white light including a red component, a green component, and a blue component to a liquid crystal panel. Conventionally, a cold cathode tube which is called CCFL has been adopted as a light source of the backlight device in many cases. In recent years, however, LEDs have been increasingly adopted from a viewpoint of low power consumption, facility of luminance control, or the like.

As described above, the liquid crystal display device of the transmission type requires the backlight device capable of radiating white light to the liquid crystal panel. Then, for example, a backlight device which has, as a light source, a white light emitting body 950 having a structure in which a blue LED element 952 is covered with a yellow phosphor 954 (refer to FIG. 26) or a backlight device which has, as a light source, a white light emitting body 960 having a structure in which a blue LED element 962 is covered with a red phosphor 964 and a green phosphor 966 (refer to FIG. 27) are used. Moreover, a backlight device which has, as a light source, a red light emitting body 930 including a red LED element 932, a green light emitting body 920 including a green LED element 922, and a blue light emitting body 940 including a blue LED element 942 (refer to FIG. 28) is also used. In each of the aforementioned configurations, each phosphor is excited by light emitted from the corresponding LED element, and emits light. Note that, though one in a state where an LED element is covered with a lens is also called “LED” generally, the one in this state is referred to as “light emitting body” in this specification for clear distinction from the LED element. Further, in this specification, one light source group which is formed to emit white light and, for example, as illustrated in FIG. 28 is referred to as “LED module”.

With the configuration illustrated in FIG. 28, a driving circuit is complicated compared with the configuration illustrated in FIG. 26 or the configuration illustrated in FIG. 27, and costs and power consumption are increased. However, a color reproduction range becomes wider in the case of adopting the configuration illustrated in FIG. 28 compared with the case of adopting the configuration illustrated in FIG. 26 or the configuration illustrated in FIG. 27. Thus, when realizing the wide color reproduction range, the LED module having the configuration illustrated in FIG. 28 has been conventionally adopted as a light source in many cases. However, due to recent progress with a technique of a phosphor used for a light emitting body, an LED module realizing a color reproduction range which is wider than that of the LED module having the configuration illustrated in FIG. 28 is provided. Specifically, an LED module constituted by, as illustrated in FIG. 29, a magenta light emitting body 910, which has a structure in which blue LED element 912 is covered with a red phosphor 914, and a green light emitting body 920 including a green LED element 922 is provided. With the LED module having the configuration illustrated in FIG. 29, light two wavelengths (a wavelength of blue and a wavelength of red) of which are peak wavelengths of an emission spectrum is emitted from the magenta light emitting body 910, and light a wavelength of green of which is a peak wavelength of an emission spectrum is emitted from the green light emitting body 920. Then, combined light of the light from the both becomes white light. According to the LED module having the configuration illustrated in FIG. 29, it is possible to obtain the color reproduction range which is wider than that of the LED module having the configuration illustrated in FIG. 28. As above, as to the liquid crystal display device, the color reproduction range is expanded by including the LED module having the configuration illustrated in FIG. 29 as the light source of the backlight device.

Note that, prior art documents below have been known relating to the invention of this specification. Japanese Unexamined Patent Application Publication No. 2008-97896 discloses a technique of enabling adjustment of color reproducibility by providing an LED for correction between a plurality of white LEDs. Japanese Unexamined Patent Application Publication No. 2008-96492 discloses a technique of optimizing color reproducibility of a display screen by adopting, as a light source, an LED module including a white LED whose relative light strength of a wavelength region of green among three primary colors is increased, a red LED, and a blue LED. Japanese Unexamined Patent Application Publication No. 2007-141548 discloses a technique of optimizing color reproducibility of a display screen by adopting, as a light source, an LED module in which a white LED, a red LED, a green LED, and a blue LED are integrated. International Publication No. 2009/110129 discloses a technique of performing high-definition multi-primary color display and precise color reproduction by adopting, as a light source, LEDs of four colors (a red LED, a green LED, a blue LED, and a cyan LED) luminance of each of which is able to be controlled independently. Japanese Unexamined Patent Application Publication No. 2008-205133 discloses a configuration in which an LED element for color adjustment which has a small size is incorporated into a light emitting body including an LED element, which has a large size, and a phosphor which is excited by light emitted from the large-sized LED element and emits light.

### CITATION LIST

### Patent Literature

PTL 1: Japanese Unexamined Patent Application Publication No. 2008-97896
PTL 2: Japanese Unexamined Patent Application Publication No. 2008-96492
PTL 3: Japanese Unexamined Patent Application Publication No. 2007-141548
PTL 4: International Publication No. 2009/110129
PTL 5: Japanese Unexamined Patent Application Publication No. 2008-205133

### SUMMARY OF INVENTION

### Technical Problem

However, in a case where the LED module having the configuration illustrated in FIG. 29 is adopted, it is difficult to suitably adjust a white point (white) by a backlight device. This will be described in detail as follows. There are some display devices capable of adjusting a color temperature, for example, in order to perform video display of a color according to a purpose. The adjustment of the color temperature is generally performed by adjusting a gain (strength of a color, which is actually displayed, with respect to strength of an input signal) of each of the three primary colors (red, green, and blue), but it is also possible to adjust the color temperature by controlling luminance of a light source. With regard to this, according to the LED module having the configuration illustrated in FIG. 29, luminance of magenta is controlled by controlling light emission from the magenta light emitting body 910, and luminance of green is controlled by controlling light emission from the green light emitting body 920 (refer to FIG. 30). However, since luminance of only two colors (magenta and green) is able to be controlled independently, as can be seen from FIG. 31, a color temperature which is able to be selected is a color temperature corresponding to coordinates 72 of an intersection point of a straight line connecting coordinates M of magenta and coordinates G of green and a blackbody locus (locus of blackbody radiation) 71 in an xy chromaticity diagram. That is, it is difficult to change the color temperature by adjusting the luminance of the light source. Accordingly, it is difficult to suitably adjust a white point (white). Thus, it is necessary to select an LED of a chromaticity rank in accordance with desired white.

Then, the invention aims to provide a backlight device for a liquid crystal display device, which is capable of suitably adjusting a white point and realizing a wide color reproduction range.

### Solution to Problem

A first aspect of the invention is a backlight device using light emitting diode elements as a light source, the backlight device including:

a first light emitting body that includes a light emitting diode element and emits light at a plurality of peak wavelengths,

a second light emitting body that includes a light emitting diode element and emits light at a peak wavelength different from the plurality of peak wavelengths of the light emitted from the first light emitting body, and

a third light emitting body that includes a light emitting diode element and emits light at at least one peak wavelength among the plurality of the peak wavelengths of the light emitted from the first light emitting body.

The first light emitting body, the second light emitting body, and the third light emitting body are configured such that luminance of the light emitted from the first light emitting body, luminance of the light emitted from the second light emitting body, and luminance of the light emitted from the third light emitting body are controlled independently of one another.

In a second aspect of the invention, based on the first aspect of the invention,

the first light emitting body includes a blue light emitting diode element and a red phosphor,

the second light emitting body includes a green light emitting diode element, and

the third light emitting body includes a red light emitting diode element.

In a third aspect of the invention, based on the first aspect of the invention,

the first light emitting body includes a blue light emitting diode element and a red phosphor,

the second light emitting body includes a green light emitting diode element, and

the third light emitting body includes a blue light emitting diode element.

In a fourth aspect of the invention, based on the first aspect of the invention,

the backlight device further includes

a fourth light emitting body that emits light at a peak wavelength, which is different from the peak wavelength of the light emitted from the third light emitting body, among the plurality of the peak wavelengths of the light emitted from the first light emitting body.

In a fifth aspect of the invention, based on the fourth aspect of the invention,

the first light emitting body includes a blue light emitting diode element and a red phosphor,

the second light emitting body includes a green light emitting diode element,

the third light emitting body includes a red light emitting diode element, and

the fourth light emitting body includes a blue light emitting diode element.

A sixth aspect of the invention is a liquid crystal display device, including:

a liquid crystal panel including a display portion on which an image is displayed;

the backlight device according to the first aspect of the invention, which radiates light to a rear surface of the liquid crystal panel; and

a backlight driving portion that independently controls each of the luminance of the light emitted from the first light emitting body, the luminance of the light emitted from the second light emitting body, and the luminance of the light emitted from the third light emitting body.

In a seventh aspect of the invention, based on the sixth aspect of the invention,

by independently controlling each of the luminance of the light emitted from the first light emitting body, the luminance of the light emitted from the second light emitting body, and the luminance of the light emitted from the third light emitting body by the backlight driving portion, a color temperature of white when the white is displayed on the display portion is able to be set to a color temperature that corresponds to certain chromaticity coordinates on a blackbody locus in a range of a triangle formed by connecting chromaticity coordinates of the light emitted from the first light emitting body, chromaticity coordinates of the light emitted from the second light emitting body, and chromaticity coordinates of the light emitted from the third light emitting body in an xy chromaticity diagram.

An eighth aspect of the invention is a backlight device using light emitting diode elements as a light source, the backlight device including:

a first light emitting diode element that emits light at a first peak wavelength,

a phosphor that is excited by the light emitted from the first light emitting diode element and emits light at a second peak wavelength,

a second light emitting diode element that emits light at a third peak wavelength, and

a third light emitting diode element that emits light at the first peak wavelength or the second peak wavelength.

The first light emitting diode element, the second light emitting diode element, and the third light emitting diode element are configured such that luminance thereof are controlled independently of one another.

In a ninth aspect of the invention, based on the eighth aspect of the invention,

the first light emitting diode element, the phosphor, and the third light emitting diode element are packaged in a light emitting body.

In a tenth aspect of the invention, based on the ninth aspect of the invention,

the first light emitting diode element is a blue light emitting diode element,

the phosphor is a red phosphor,

the second light emitting diode element is a green light emitting diode element, and

the third light emitting diode element is a red light emitting diode element.

In an eleventh aspect of the invention, based on the eighth aspect of the invention,

the first light emitting diode element, the phosphor, the second light emitting diode element, and the third light emitting diode element are packaged in a light emitting body.

In a twelfth aspect of the invention, based on the eleventh aspect of the invention,

the first light emitting diode element is a blue light emitting diode element,

the phosphor is a red phosphor,

the second light emitting diode element is a green light emitting diode element, and

the third light emitting diode element is a red light emitting diode element.

In a thirteenth aspect of the invention, based on the eleventh aspect of the invention,

the first light emitting diode element is a blue light emitting diode element,

the phosphor is a red phosphor,

the second light emitting diode element is a green light emitting diode element, and

the third light emitting diode element is a blue light emitting diode element.

A fourteenth aspect of the invention is a liquid crystal display device, including:

a liquid crystal panel including a display portion on which an image is displayed;

the backlight device according to the eighth aspect of the invention, which radiates light to a rear surface of the liquid crystal panel; and

a backlight driving portion that independently controls each of the luminance of the light emitted from the first light emitting diode element, the luminance of the light emitted from the second light emitting diode element, and the luminance of the light emitted from the third light emitting diode element.

In a fifteenth aspect of the invention, based on the fourteenth aspect of the invention,

by independently controlling each of the luminance of the light emitted from the first light emitting diode element, the luminance of the light emitted from the second light emitting diode element, and the luminance of the light emitted from the third light emitting diode element by the backlight driving portion, a color temperature of white when the white is displayed on the display portion is able to be set to a color temperature that corresponds to certain chromaticity coordinates on a blackbody locus in a range of a triangle formed by connecting chromaticity coordinates of combined light of the light emitted from the first light emitting diode element and the light emitted from the phosphor, chromaticity coordinates of the light emitted from the second diode element, and chromaticity coordinates of the light emitted from the third diode element in an xy chromaticity diagram.

In a sixteenth aspect of the invention, based on the fifteenth aspect of the invention,

the display portion is logically divided into a plurality of areas, and

the backlight driving portion controls, for each of the areas, the luminance of the light emitted from the first light emitting diode element, the luminance of the light emitted from the second light emitting diode element, and the luminance of the light emitted from the third light emitting diode element.

### Advantageous Effects of Invention

According to the first aspect of the invention, the first light emitting body which emits the light having the plurality of peak wavelengths, the second light emitting body which emits the light having one peak wavelength different from the plurality of peak wavelengths that the light emitted from the first light emitting body has, and the third light emitting body which emits the light having at least one peak wavelength among the plurality of peak wavelengths that the light emitted from the first light emitting body has are used as the light source of the backlight device. Accordingly, by controlling each of light emission from the first light emitting body, light emission from the second light emitting body, and light emission from the third light emitting body, it is possible to independently control luminance of three colors. Thus, it becomes possible to change color temperature. This makes it possible to suitably adjust a white point (white), so that display quality is improved. In addition, by including the phosphor into the first light emitting body, it is possible to make a color reproduction range wider compared with a case where a red light emitting diode element, a green light emitting diode element, and a blue light emitting diode element are used as a light source. As above, the backlight device which is capable of suitably adjusting a white point and realizing a wide color reproduction range is provided.

According to the second aspect of the invention, it is possible to independently control luminance of three colors of magenta, green, and red. Thus, it becomes possible to set color temperature of white when the white is displayed to be color temperature corresponding to certain chromaticity coordinates on a blackbody locus in a range of a triangle formed by connecting chromaticity coordinates of magenta, chromaticity coordinates of green, and chromaticity coordinates of red in an xy chromaticity diagram.

According to the third aspect of the invention, it is possible to independently control luminance of three colors of magenta, green, and blue. Thus, it becomes possible to set color temperature of white when the white is displayed to be color temperature corresponding to certain chromaticity coordinates on a blackbody locus in a range of a triangle formed by connecting chromaticity coordinates of magenta, chromaticity coordinates of green, and chromaticity coordinates of blue in an xy chromaticity diagram.

According to the fourth aspect of the invention, in addition to the first light emitting body, the second light emitting body, and the third light emitting body, the fourth light emitting body which emits the light having a peak wavelength, which is different from the peak wavelength that the light emitted from the third light emitting body has, among the plurality of peak wavelengths that the light emitted from the first light emitting body has is used as the light source of the backlight device. Accordingly, it becomes possible to change color temperature by independently controlling luminance of four colors. This makes it possible to adjust a white point (white) more flexibly.

According to the fifth aspect of the invention, it is possible to independently control luminance of four colors of magenta, green, red, and blue. Thus, it becomes possible to set color temperature of white when the white is displayed to be color temperature corresponding to certain chromaticity coordinates on a blackbody locus in a range of a triangle formed by connecting chromaticity coordinates of red, chromaticity coordinates of green, and chromaticity coordinates of blue in an xy chromaticity diagram.

According to the sixth aspect of the invention, the liquid crystal display device which is capable of, by controlling the luminance of the light source of the backlight device, suitably adjusting a white point and realizing a wide color reproduction range is provided.

According to the seventh aspect of the invention, it is possible to obtain an effect similar to that of the sixth aspect of the invention.

According to the eighth aspect of the invention, by controlling each of the luminance of the light emitted from the first light emitting diode element, the luminance of the light emitted from the second light emitting diode element, and the luminance of the light emitted from the third light emitting diode element, it is possible to independently control the luminance of three colors. Thus, it becomes possible to change color temperature. This makes it possible to suitably adjust a white point (white), so that display quality is improved. In addition, by including the phosphor into the light source, it is possible to make a color reproduction range wider compared with a case where a red light emitting diode element, a green light emitting diode element, and a blue light emitting diode element are used as a light source. As above, the backlight device which is capable of suitably adjusting a white point and realizing a wide color reproduction range is provided.

According to the ninth aspect of the invention, it is possible to reduce the number of light emitting bodies, so that it is possible to obtain an effect similar to that of the eighth aspect of the invention while achieving miniaturization.

According to the tenth aspect of the invention, it is possible to obtain an effect similar to that of the second aspect of the invention.

According to the eleventh aspect of the invention, it is possible to remarkably reduce the number of light emitting bodies, so that it is possible to obtain an effect similar to that of the eighth aspect of the invention while achieving remarkable miniaturization.

According to the twelfth aspect of the invention, it is possible to obtain an effect similar to that of the second aspect of the invention.

According to the thirteenth aspect of the invention, it is possible to obtain an effect similar to that of the third aspect of the invention.

According to the fourteenth aspect of the invention, the liquid crystal display device which is capable of, by controlling the luminance of the light emitted from the light emitting diode elements in the backlight device, suitably adjusting a white point and realizing a wide color reproduction range is provided.

According to the fifteenth aspect of the invention, it is possible to obtain an effect similar to that of the fourteenth aspect of the invention.

According to the sixteenth aspect of the invention, it is possible to control, for each of the areas, the luminance of the light emitted from the light emitting diode elements in the backlight device. Therefore, it becomes possible to suitably adjust a white point regardless of variation of characteristics of the light source. Thereby, the backlight device for a liquid crystal display device, which is capable of suppressing generation of color unevenness on a screen and realizing a wide color reproduction range, is provided.

### BRIEF DESCRIPTION OF DRAWINGS

FIG. 1 is a view for explaining adjustment of a white point by a backlight device according to a first embodiment of the invention.

FIG. 2 is a block diagram illustrating an entire configuration of a liquid crystal display device including the backlight device according to the first embodiment.

FIG. 3 is a view illustrating a schematic configuration of the backlight device in the first embodiment.

FIG. 4 is a view illustrating a configuration of an LED module to be mounted on an LED substrate in the first embodiment.

FIG. 5 is a circuit diagram illustrating a configuration example of a backlight driving circuit in the first embodiment.

FIG. 6 is an xy chromaticity diagram for explaining adjustment of a white point by the backlight device according to the first embodiment.

FIG. 7 is a view for explaining a difference in emission spectra due to a difference of configurations of LED modules.

FIG. 8 is an xy chromaticity diagram for explaining a difference of color reproduction ranges due to the difference of the configurations of the LED modules.

FIG. 9 is a view illustrating a configuration of an LED module to be mounted on an LED substrate in a second embodiment of the invention.

FIG. 10 is a view for explaining adjustment of a white point by a backlight device according to the second embodiment.

FIG. 11 is an xy chromaticity diagram for explaining adjustment of a white point by the backlight device according to the second embodiment.

FIG. 12 is a view illustrating a configuration of an LED module to be mounted on an LED substrate in a third embodiment of the invention.

FIG. 13 is a view for explaining adjustment of a white point by a backlight device according to the third embodiment.

FIG. 14 is an xy chromaticity diagram for explaining adjustment of a white point by the backlight device according to the third embodiment.

FIG. 15 is a view for explaining local dimming processing.

FIG. 16 is a view illustrating a configuration of an LED module to be mounted on an LED substrate in a fourth embodiment of the invention.

FIG. 17 is a view for explaining adjustment of a white point by a backlight device according to the fourth embodiment.

FIG. 18 is an xy chromaticity diagram for explaining adjustment of a white point by the backlight device according to the fourth embodiment.

FIG. 19 is a view for explaining an effect in the fourth embodiment.

FIG. 20 is a view illustrating a configuration of an LED module to be mounted on an LED substrate in a fifth embodiment of the invention.

FIG. 21 is a view for explaining adjustment of a white point by a backlight device according to the fifth embodiment.

FIG. 22 is a view illustrating a configuration of an LED module to be mounted on an LED substrate in a sixth embodiment of the invention.

FIG. 23 is a view for explaining adjustment of a white point by a backlight device according to the sixth embodiment.

FIG. 24 is a waveform chart for explaining occurrence of color breaking.

FIG. 25 is a waveform chart for explaining an effect of suppressing color breaking by the second embodiment.

FIG. 26 is a view for explaining a conventional backlight device.

FIG. 27 is a view for explaining a conventional backlight device.

FIG. 28 is a view for explaining a conventional backlight device.

FIG. 29 is a view for explaining a conventional backlight device.

FIG. 30 is a view for explaining adjustment of a white point by the conventional backlight device.

FIG. 31 is an xy chromaticity diagram for explaining adjustment of a white point by the conventional backlight device.

### DESCRIPTION OF EMBODIMENTS

Hereinafter, embodiments of the invention will be described with reference to appended drawings. Note that, in second to sixth embodiments, description of points similar to those of a first embodiment will be omitted as appropriate.

### 1. First Embodiment

### 1.1 Entire Configuration and Operation

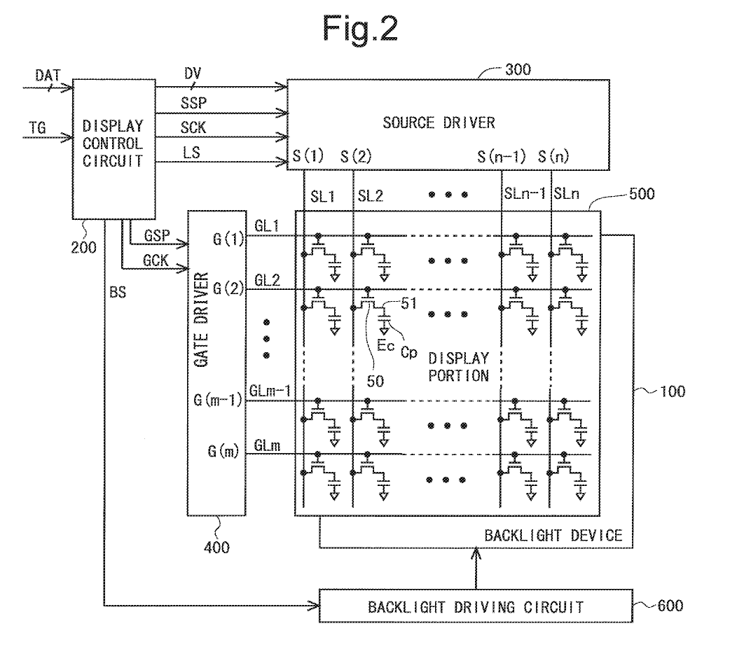

FIG. 2 is a block diagram illustrating an entire configuration of a liquid crystal display device including a backlight device according to the first embodiment of the invention. The liquid crystal display device includes a backlight device 100, a display control circuit 200, a source driver (video signal line driving circuit) 300, a gate driver (scanning signal line driving circuit) 400, a display portion 500, and a backlight driving circuit 600.

The display portion 500 includes a plurality of (n) source bus lines (video signal lines) SL1 to SLn, a plurality of (m) gate bus lines (scanning signal lines) GL1 to GLm, and a plurality of (n×m) pixel forming parts which are provided so as to respectively correspond to intersections of the plurality of source bus lines SL1 to SLn and the plurality of gate bus lines GL1 to GLm. The pixel forming parts are arranged in a matrix, and constitute a pixel array. Each of the pixel forming parts includes a thin film transistor (TFT) 50 which is a switching element a gate terminal of which is connected to a gate bus line passing through a corresponding intersection and a source terminal of which is connected to a source bus line passing through this intersection, a pixel electrode 51 which is connected to a drain terminal of the thin film transistor 50, a common electrode Ec which is a counter electrode provided commonly to the plurality of pixel forming parts, and a liquid crystal layer which is provided commonly to the plurality of pixel forming parts and held between the pixel electrode 51 and the common electrode Ec. Then, a pixel capacitor Cp is constituted by a liquid crystal capacitor formed by the pixel electrode 51 and the common electrode Ec. Note that, in order to reliably maintain a voltage at the pixel capacitor Cp, an auxiliary capacitor is generally provided in parallel to the liquid crystal capacitor. However, the auxiliary capacitor is not directly related to the invention, so that description and illustration thereof will be omitted.

The backlight device 100 is provided on a rear surface side of a liquid crystal panel which includes the display portion 500, and radiates backlight to a rear surface of the liquid crystal panel. The backlight device 100 includes LEDs (light emitting diodes) as a light source. Note that, a detailed configuration of the backlight device 100 will be described below.

The display control circuit 200 receives an image signal DAT which is transmitted from an outside and a timing signal group TG of a horizontal synchronizing signal, a vertical synchronizing signal, and the like, and outputs digital video signals DV; a source start pulse signal SSP, a source clock signal SCK, and a latch strobe signal LS which are for controlling an operation of the source driver 300; a gate start pulse signal GSP and a gate clock signal GCK which are for controlling an operation of the gate driver 400; and a backlight control signal BS which is for controlling an operation of the backlight driving circuit 600.

The source driver 300 receives the digital video signals DV, the source start pulse signal SSP, the source clock signal SCK, and the latch strobe signal LS, which are transmitted from the display control circuit 200, and applies video signals for driving S(1) to S(n) to the source bus lines SL1 to SLn. At this time, in the source driver 300, the digital video signals DV each of which indicates a voltage to be applied to each of the source bus lines SL1 to SLn are maintained successively at a timing when a pulse of the source clock signal SCK is generated. Then, at a timing when a pulse of the latch strobe signal LS is generated, the maintained digital video signals DV are converted into analogue voltages. The converted analogue voltages are simultaneously applied to all of the source bus lines SL1 to SLn as the video signals for driving S(1) to S(n).

Based on the gate start pulse signal GSP and the gate clock signal GCK which are transmitted from the display control circuit 200, the gate driver 400 repeats applying active scanning signals G(1) to G(m) to the gate bus lines GL1 to GLm, respectively, with one vertical scanning period as a cycle.

The backlight driving circuit 600 controls luminance of the light source (LEDs) in the backlight device 100 based on the backlight control signal BS which is transmitted from the display control circuit 200.

In such a manner, the scanning signals G(1) to G(m) are applied to the gate bus lines GL1 to GLm, respectively, the video signals for driving S(1) to S(n) are applied to the source bus lines SL1 to SLn, respectively, and the luminance of the light source in the backlight device 100 is controlled, and thereby an image according to the image signal DAT which is transmitted from the outside is displayed on the display portion 500.

### 1.2 Configuration of Backlight Device

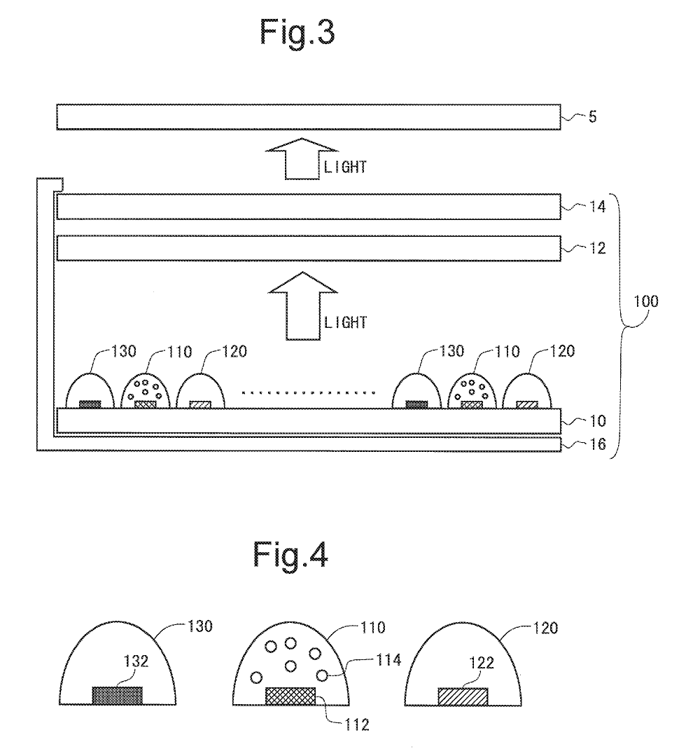

FIG. 3 is a view illustrating a schematic configuration of the backlight device 100 in the present embodiment. Note that, FIG. 3 is a side view of a liquid crystal panel 5 and the backlight device 100. The backlight device 100 is provided on the rear surface side of the liquid crystal panel 5. That is, the backlight device 100 of a direct type is adopted in the present embodiment. The backlight device 100 is constituted by an LED substrate 10 on which a plurality of light emitting bodies are mounted as the light source, a diffusion plate 12 by which light emitted from the light emitting bodies is diffused and made uniform, an optical sheet 14 by which efficiency of light to be radiated toward the liquid crystal panel 5 is improved, and a chassis 16 which supports the LED substrate 10 and the like.

### 1.3 Configuration of LED Module

FIG. 4 is a view illustrating a configuration of an LED module to be mounted on the LED substrate 10. In the present embodiment, the LED module is constituted by a magenta light emitting body 110 having a structure in which a blue LED element 112 is covered with a red phosphor 114, a green light emitting body 120 including a green LED element 122, and a red light emitting body 130 including a red LED element 132. That is, in the configuration of the LED module in the present embodiment, the red light emitting body 130 including the red LED element 132 is added to the configuration of the conventional example, which is illustrated in FIG. 29. The red light emitting body 130 functions as a light emitting body for color adjustment.

Note that, in the present embodiment, a first light emitting body is realized by the magenta light emitting body 110, a second light emitting body is realized by the green light emitting body 120, and a third light emitting body is realized by the red light emitting body 130.

The magenta light emitting body 110 emits magenta light (light a wavelength of blue and a wavelength of red of which are peak wavelengths of an emission spectrum). The green light emitting body 120 emits green light (light a wavelength of green of which is a peak wavelength of an emission spectrum). The red light emitting body 130 emits red light (light a wavelength of red of which is a peak wavelength of an emission spectrum). The magenta light, the green light, and the red light are emitted from the magenta light emitting body 110, the green light emitting body 120, and the red light emitting body 130 in this manner, respectively, and thereby white light is radiated to the liquid crystal panel 5.

### 1.4 Configuration of Backlight Driving Circuit

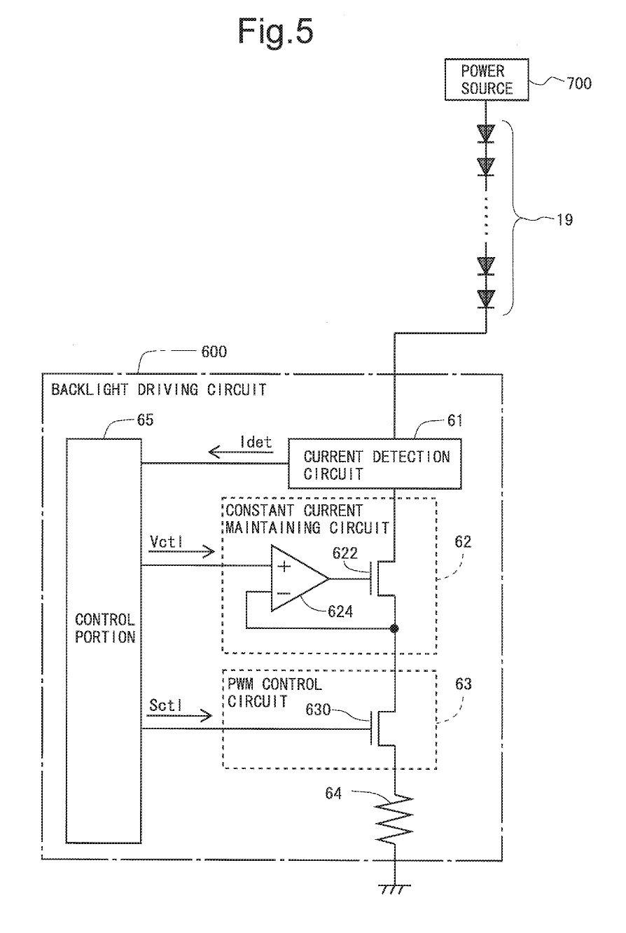

FIG. 5 is a circuit diagram illustrating a configuration example of the backlight driving circuit 600 in the present embodiment. Note that, in FIG. 5, the light emitting diode elements used as the light source are collectively indicated with a reference sign 19. In addition, constituents for driving the light emitting diode elements 19 of one system, which are connected in series, are illustrated in FIG. 5. Note that, a current which passes through the light emitting diode elements 19 is referred to as a “lighting current” below.

As illustrated in FIG. 5, a plurality of light emitting diode elements 19 of one system are connected in series between a power source 700 and the backlight driving circuit 600. The backlight driving circuit 600 has a current detection circuit 61, a constant current maintaining circuit 62, a PWM control circuit 63, a resistor 64, and a control portion 65.

The current detection circuit 61 detects the lighting current. A detected current value Idet which is a result of the detection of the lighting current by the current detection circuit 61 is applied to the control portion 65. Note that, the current detection circuit 61 is realized by a known circuit using a shunt resistor or a differential amplifier, for example.

The constant current maintaining circuit 62 performs control so that a constant current according to target luminance passes through the light emitting diode elements 19. The constant current maintaining circuit 62 includes, for example, an FET (field effect transistor) 622 and an operational amplifier 624 as illustrated in FIG. 5. As to the FET 622, a gate terminal is connected to an output terminal of the operational amplifier 624, a drain terminal is connected to the current detection circuit 61, and the source terminal is connected to the PWM control circuit 63 and an inverting input terminal of the operational amplifier 624. A control voltage Vct1 is applied to a non-inverting input terminal of the operational amplifier 624 from the control portion 65. Since, with the configuration above, negative feedback is applied to the operational amplifier 624, the operational amplifier 624 operates so that a voltage between the non-inverting input terminal and the inverting input terminal of the operational amplifier 624 becomes 0 by imaginary short. Accordingly, a source voltage of the FET 622 is constantly Vct1. Based on the source voltage and a resistance value of the resistor 64, a constant current passes through the light emitting diode elements 19. Note that, since magnitude of the control voltage Vct1 output from the control portion 65 changes when the target luminance changes, magnitude of the current passing through the light emitting diode elements 19 also changes in accordance with the target luminance.

The PWM control circuit 63 includes a transistor 630. The PWM control circuit 63 controls on/off of the transistor 630 in accordance with a pulse width of a control signal Sct1, which is provided from the control portion 65, to thereby control magnitude of the lighting current. When the pulse width of the control signal Sct1 is long, time during which the transistor 630 is in an on state becomes relatively long, so that the magnitude of the lighting current becomes great. On the other hand, when the pulse width of the control signal Sct1 is short, the time during which the transistor 630 is in the on state becomes relatively short, so that the magnitude of the lighting current becomes small.

Based on the target luminance of the light emitting diode elements 19 and the detected current value Idet, the control portion 65 applies the control voltage Vct1 to the constant current maintaining circuit 62 and provides the control signal Sct1 to the PWM control circuit 63 so that the lighting current whose magnitude is according to the target luminance passes through the light emitting diode elements 19.

In the present embodiment, the magnitude of the lighting current of each of the LED elements included in the magenta light emitting body 110, the green light emitting body 120, and the red light emitting body 130 is independently controlled by the backlight driving circuit 600 having the configuration above, for example. That is, light emission from the magenta light emitting body 110, light emission from the green light emitting body 120, and light emission from the red light emitting body 130 are independently controlled. Thereby, each of luminance of magenta, luminance of green, and luminance of red is independently controlled.

### 1.5 Adjustment of White Point

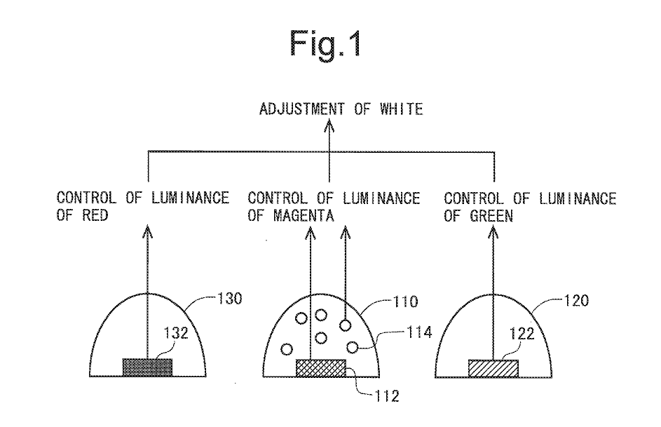

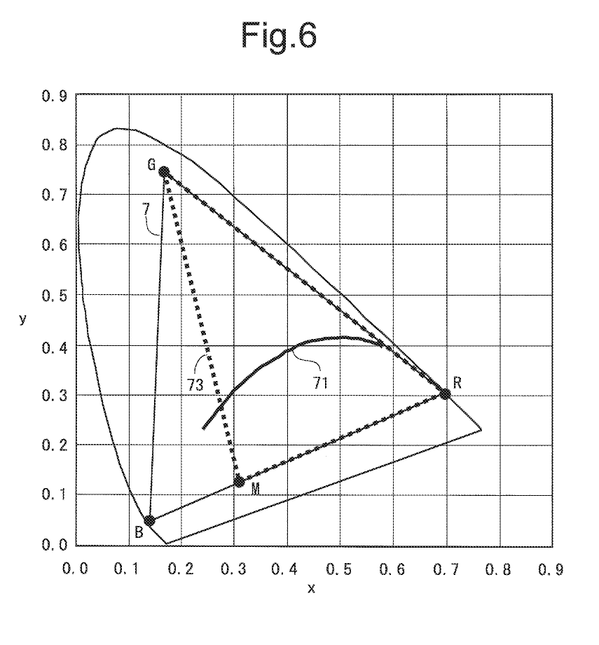

Next, adjustment of a white point will be described. As described above, in a case where the LED module in the conventional example, which has the configuration illustrated in FIG. 29, is adopted, luminance of only two colors (magenta and green) is able to be independently controlled, so that it is difficult to change color temperature by adjusting luminance of the light source, and to suitably adjust a white point (white). Meanwhile, in the present embodiment, luminance of magenta is controlled by controlling light emission from the magenta light emitting body 110, luminance of green is controlled by controlling light emission from the green light emitting body 120, and luminance of red is controlled by controlling light emission from the red light emitting body 130, as illustrated in FIG. 1. That is, it is possible to independently control luminance of three colors of magenta, green, and red. Accordingly, as can be seen from FIG. 6, it is possible to select, as a white point, chromaticity coordinates in a range of a triangle 73 formed by connecting chromaticity coordinates M of magenta, chromaticity coordinates G of green, and chromaticity coordinates R of red in an xy chromaticity diagram. Concerning this, color temperature corresponding to chromaticity coordinates on a blackbody locus 71 in the range of the triangle 73 is typically selected as desired color temperature (color temperature of white when the white is displayed on the display portion 500). In this manner, color temperature is able to be changed by adjusting luminance of the light source, so that it becomes possible to suitably adjust a white point (white). Note that, control of light emission from each light emitting body is performed by the backlight driving circuit 600 based on the backlight control signal BS.

### 1.6 Color Reproduction Range

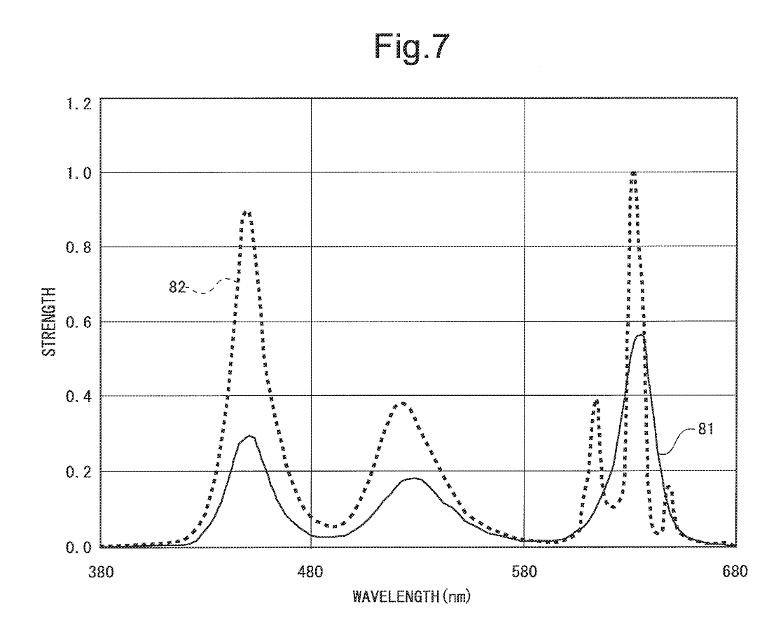

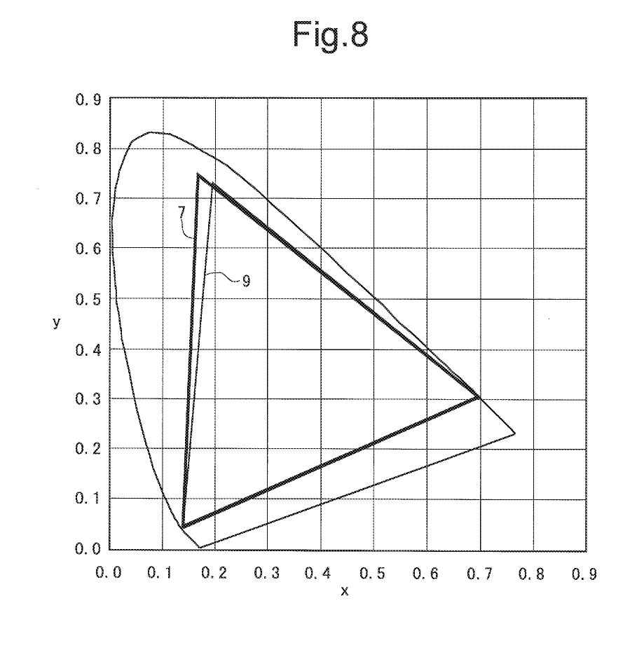

In a case where an LED module is constituted by a red light emitting body including a red LED element, a green light emitting body including a green LED element, and a blue light emitting body including a blue LED element in order to obtain white light (that is, a case where the LED module having the configuration illustrated in FIG. 28 is adopted), an emission spectrum from this LED module is represented with a curved line as indicated with a reference sign 81 in FIG. 7. Meanwhile, in a case where an LED module is constituted by a magenta light emitting body having a structure in which a blue LED element is covered with a red phosphor, and a green light emitting body including a green LED element in order to obtain white light (that is, a case where the LED module having the configuration illustrated in FIG. 29 is adopted), an emission spectrum from this LED module is represented with a curved line as indicated with a reference sign 82 in FIG. 7. Based on these emission spectra, while a color reproduction range in a case where the LED module having the configuration illustrated in FIG. 28 is adopted is represented with a triangle indicated with a reference sign 9 in FIG. 8, a color reproduction range in a case where the LED module having the configuration illustrated in FIG. 29 is adopted is represented with a triangle indicated with a reference sign 7 in FIG. 8. As described above, the LED module of the present embodiment has the configuration in which the red light emitting body 130 including the red LED element 132 is added to the configuration illustrated in FIG. 29. Thus, in the present embodiment, it is possible to obtain a color reproduction range which is at least equivalent to that of the case where the LED module having the configuration illustrated in FIG. 29 is adopted.

### 1.7 Effect

According to the present embodiment, the LED module which constitutes the backlight device 100 includes the red light emitting body 130 including the red LED element 132, which functions as the light emitting body for color adjustment, in addition to the magenta light emitting body 110 having the structure in which the blue LED element 112 is covered with the red phosphor 114 and the green light emitting body 120 including the green LED element 122. Therefore, it is possible to independently control luminance of the three colors of magenta, green, and red by controlling light emission from each of the light emitting bodies. Accordingly, it becomes possible to change color temperature. This makes it possible to suitably adjust a white point, so that display quality is improved. Moreover, by using the red phosphor 114, the color reproduction range becomes wider compared with the case where an LED module which is constituted by a red light emitting body including a red LED element, a green light emitting body including a green LED element, and a blue light emitting body including a blue LED element is adopted. As above, according to the present embodiment, a backlight device for a liquid crystal display device, which is capable of suitably adjusting a white point and realizing a wide color reproduction range, is provided.

### 2. Second Embodiment

### 2.1 Configuration

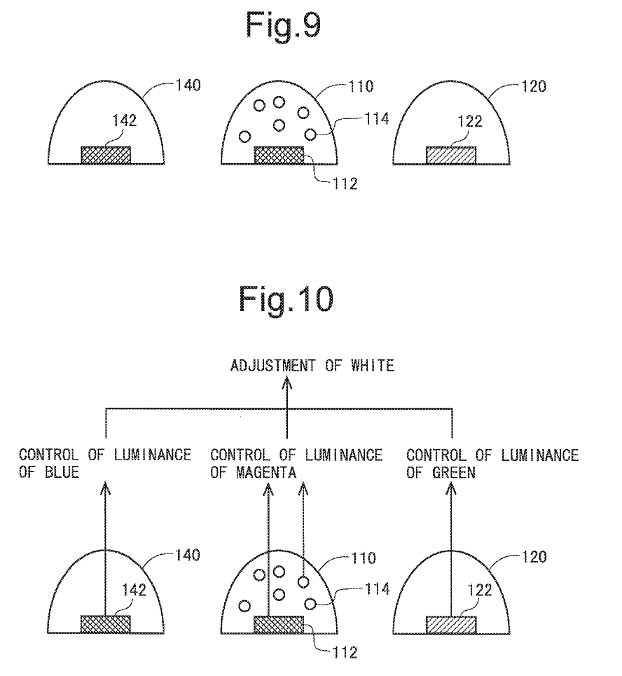

Since an entire configuration (refer to FIG. 2) and a configuration of the backlight device 100 (FIG. 3) are similar to those of the first embodiment, description thereof will be omitted. However, concerning FIG. 3, a configuration of an LED module of the present embodiment, which is to be mounted on the LED substrate 10, is different from that of the first embodiment. FIG. 9 is a view illustrating the configuration of the LED module to be mounted on the LED substrate 10 in the present embodiment. In the present embodiment, the LED module is constituted by the magenta light emitting body 110 having the structure in which the blue LED element 112 is covered with the red phosphor 114, the green light emitting body 120 including the green LED element 122, and a blue light emitting body 140 including a blue LED element 142. That is, the LED module in the present embodiment has a configuration in which the blue light emitting body 140 including the blue LED element 142 is added to the configuration of the conventional example, which is illustrated in FIG. 29. The blue light emitting body 140 functions as a light emitting body for color adjustment.

Note that, in the present embodiment, a first light emitting body is realized by the magenta light emitting body 110, a second light emitting body is realized by the green light emitting body 120, and a third light emitting body is realized by the blue light emitting body 140.

The magenta light emitting body 110 emits magenta light. The green light emitting body 120 emits green light. The blue light emitting body 140 emits blue light. The magenta light, the green light, and the blue light are emitted from the magenta light emitting body 110, the green light emitting body 120, and the blue light emitting body 140 in this manner, respectively, and thereby white light is radiated to the liquid crystal panel 5.

### 2.2 Adjustment of White Point

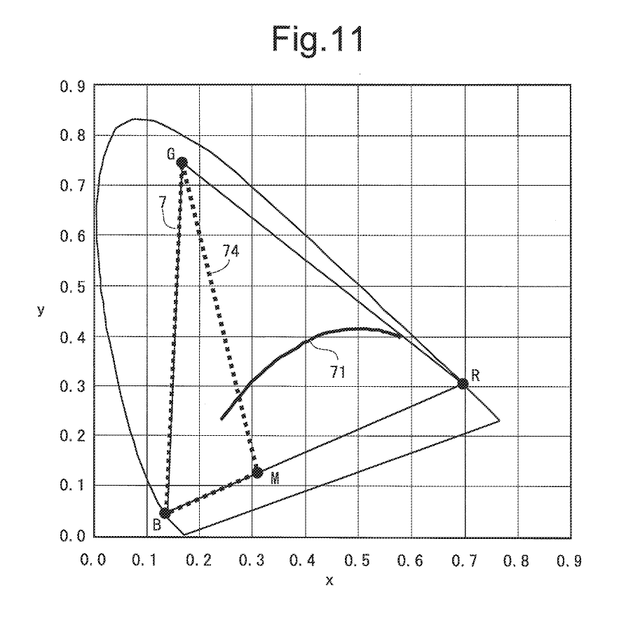

Next, adjustment of a white point will be described. In the present embodiment, luminance of magenta is controlled by controlling light emission from the magenta light emitting body 110, luminance of green is controlled by controlling light emission from the green light emitting body 120, and luminance of blue is controlled by controlling light emission from the blue light emitting body 140, as illustrated in FIG. 10. That is, it is possible to independently control luminance of three colors of magenta, green, and blue. Accordingly, as can be seen from FIG. 11, it is possible to select, as a white point, chromaticity coordinates in a range of a triangle 74 formed by connecting the chromaticity coordinates M of magenta, the chromaticity coordinates G of green, and chromaticity coordinates B of blue in an xy chromaticity diagram. Concerning this, color temperature corresponding to chromaticity coordinates on the blackbody locus 71 in the range of the triangle 74 is typically selected as desired color temperature (color temperature of white when the white is displayed on the display portion 500). In this manner, color temperature is able to be changed by adjusting luminance of the light source, so that it becomes possible to suitably adjust a white point (white). In addition, for the reason similar to that of the first embodiment, it is possible to obtain a wider color reproduction range also in the present embodiment compared with the case where an LED module (the LED module having the configuration illustrated in FIG. 28) which is constituted by a red light emitting body including a red LED element, a green light emitting body including a green LED element, and a blue light emitting body including a blue LED element in order to obtain white light is adopted.

### 2.3 Effect

According to the present embodiment, the LED module which constitutes the backlight device 100 includes the blue light emitting body 140 including the blue LED element 142, which functions as the light emitting body for color adjustment, in addition to the magenta light emitting body 110 having the structure in which the blue LED element 112 is covered with the red phosphor 114 and the green light emitting body 120 including the green LED element 122. Therefore, it is possible to independently control luminance of the three colors of magenta, green, and blue by controlling light emission from each of the light emitting bodies. Accordingly, it becomes possible to change color temperature. This makes it possible to suitably adjust a white point, so that display quality is improved. Moreover, by using the red phosphor 114, the color reproduction range becomes wider compared with the case where an LED module which is constituted by a red light emitting body including a red LED element, a green light emitting body including a green LED element, and a blue light emitting body including a blue LED element is adopted. As above, according to the present embodiment, a backlight device for a liquid crystal display device, which is capable of suitably adjusting a white point and realizing a wide color reproduction range, is provided.

### 3. Third Embodiment

### 3.1 Configuration

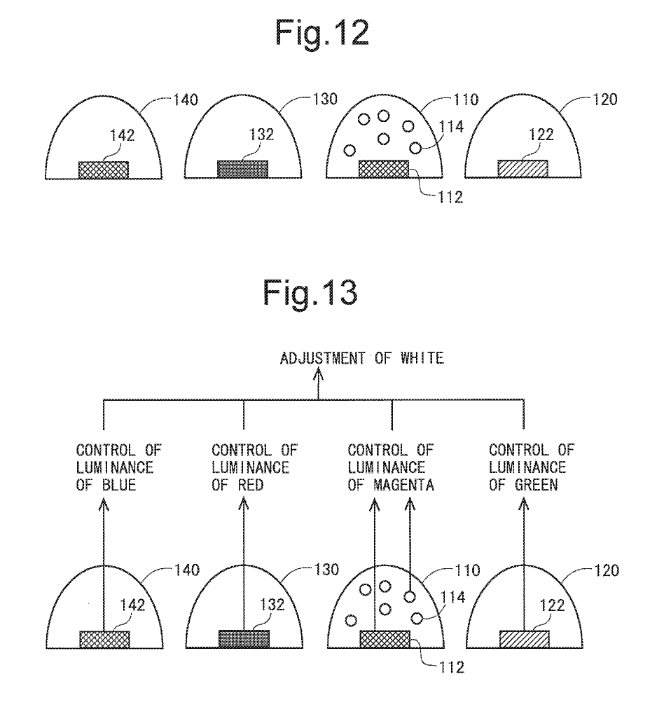

Since an entire configuration (refer to FIG. 2) and a configuration of the backlight device 100 (FIG. 3) are similar to those of the first embodiment, description thereof will be omitted. However, concerning FIG. 3, a configuration of an LED module of the present embodiment, which is to be mounted on the LED substrate 10, is different from that of the first embodiment. FIG. 12 is a view illustrating the configuration of the LED module to be mounted on the LED substrate 10 in the present embodiment. In the present embodiment, the LED module is constituted by the magenta light emitting body 110 having the structure in which the blue LED element 112 is covered with the red phosphor 114, the green light emitting body 120 including the green LED element 122, the red light emitting body 130 including the red LED element 132, and the blue light emitting body 140 including the blue LED element 142. That is, the LED module in the present embodiment has a configuration in which the red light emitting body 130 including the red LED element 132 and the blue light emitting body 140 including the blue LED element 142 are added to the configuration of the conventional example, which is illustrated in FIG. 29. The red light emitting body 130 and the blue light emitting body 140 function as light emitting bodies for color adjustment.

Note that, in the present embodiment, a first light emitting body is realized by the magenta light emitting body 110, a second light emitting body is realized by the green light emitting body 120, a third light emitting body is realized by the red light emitting body 130, and a fourth light emitting body is realized by the blue light emitting body 140.

The magenta light emitting body 110 emits magenta light. The green light emitting body 120 emits green light. The red light emitting body 130 emits red light. The blue light emitting body 140 emits blue light. The magenta light, the green light, the red light, and the blue light are emitted from the magenta light emitting body 110, the green light emitting body 120, the red light emitting body 130, and the blue light emitting body 140 in this manner, respectively, and thereby white light is radiated to the liquid crystal panel 5.

### 3.2 Adjustment of White Point

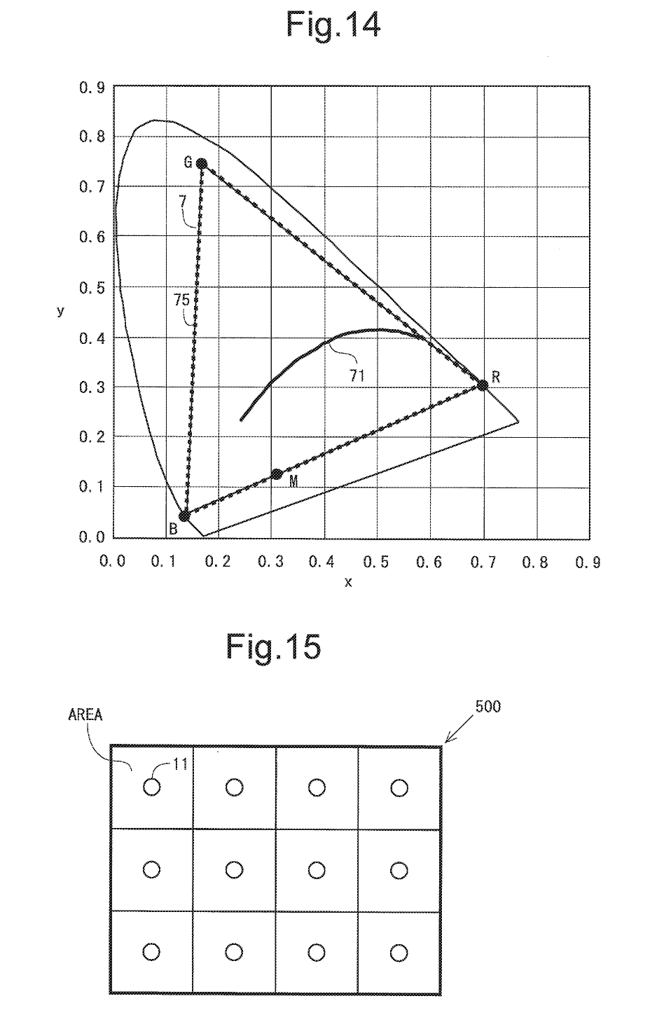

Next, adjustment of a white point will be described. In the present embodiment, luminance of magenta is controlled by controlling light emission from the magenta light emitting body 110, luminance of green is controlled by controlling light emission from the green light emitting body 120, luminance of red is controlled by controlling light emission from the red light emitting body 130, and luminance of blue is controlled by controlling light emission from the blue light emitting body 140, as illustrated in FIG. 13. That is, it is possible to independently control luminance of four colors of magenta, green, red, and blue. Accordingly, as can be seen from FIG. 14, it is possible to select, as a white point, chromaticity coordinates in a range of a triangle 75 formed by connecting the chromaticity coordinates R of red, the chromaticity coordinates G of green, and chromaticity coordinates B of blue in an xy chromaticity diagram. Concerning this, color temperature corresponding to chromaticity coordinates on the blackbody locus 71 in the range of the triangle 75 is typically selected as desired color temperature (color temperature of white when the white is displayed on the display portion 500). In this manner, color temperature is able to be changed by adjusting luminance of the light source, so that it becomes possible to suitably adjust a white point (white). In addition, for the reason similar to that of the first embodiment, it is possible to obtain a wider color reproduction range also in the present embodiment compared with the case where an LED module (the LED module having the configuration illustrated in FIG. 28) which is constituted by a red light emitting body including a red LED element, a green light emitting body including a green LED element, and a blue light emitting body including a blue LED element in order to obtain white light is adopted.

### 3.3 Effect

According to the present embodiment, the LED module which constitutes the backlight device 100 includes the red light emitting body 130 including the red LED element 132 and the blue light emitting body 140 including the blue LED element 142 in addition to the magenta light emitting body 110 having the structure in which the blue LED element 112 is covered with the red phosphor 114 and the green light emitting body 120 including the green LED element 122. The red light emitting body 130 and the blue light emitting body 140 function as the light emitting bodies for color adjustment. As above, it is possible to independently control luminance of the four colors of magenta, green, red, and blue by controlling light emission from each of the light emitting bodies. Accordingly, it becomes possible to change color temperature. This makes it possible to suitably adjust a white point, so that display quality is improved. Moreover, by using the red phosphor 114, the color reproduction range becomes wider compared with the case where an LED module which is constituted by a red light emitting body including a red LED element, a green light emitting body including a green LED element, and a blue light emitting body including a blue LED element is adopted. As above, according to the present embodiment, a backlight device for a liquid crystal display device, which is capable of suitably adjusting a white point and realizing a wide color reproduction range, is provided.

### 4. Fourth Embodiment

### 4.1 Summary

Conventionally, there has been a problem of reduction in power consumption as to a liquid crystal display device. Then, in these years, a liquid crystal display device performing local dimming processing by which a screen is logically divided into a plurality of areas and luminance of a light source is controlled for each of the areas has been developed. In the local dimming processing, luminance of a light source of a backlight device is controlled based on an input image in a corresponding area. Specifically, luminance of each light source is obtained based on a maximum value, an average value, or the like of target luminance (luminance corresponding to an input gradation value) of a pixel included in a corresponding area. Then, in an area in which luminance of the light source is made smaller than the original luminance, transmittance of each pixel is increased. Thereby, it is possible to obtain targeted display luminance in each pixel.

In the present embodiment, for example, the display portion 500 is logically divided into a plurality of areas as illustrated in FIG. 15. A corresponding LED module (one light source group) 11 is provided in each of the areas. Note that, a plurality of LED modules 11 may be provided in one area. Adjustment of a white point is enabled for each area in the configuration above. Description will hereinafter be given in detail.

### 4.2 Configuration

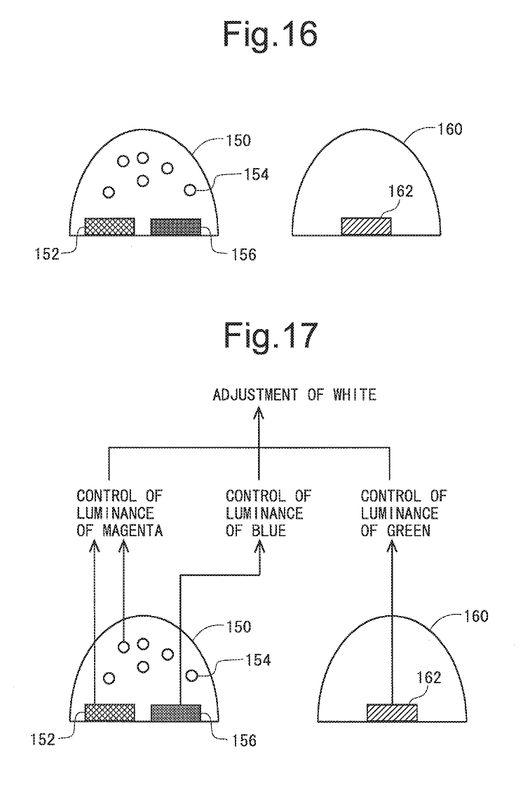

Since an entire configuration (refer to FIG. 2) and a configuration of the backlight device 100 (FIG. 3) are similar to those of the first embodiment, description thereof will be omitted. However, concerning FIG. 3, a configuration of an LED module of the present embodiment, which is to be mounted on the LED substrate 10, is different from that of the first embodiment. FIG. 16 is a view illustrating the configuration of the LED module to be mounted on the LED substrate 10 in the present embodiment. In the present embodiment, the LED module is constituted by a magenta light emitting body 150 in which a blue LED element 152, a red phosphor 154, and a red LED element 156 are packaged as one light emitting body, and a green light emitting body 160 including a green LED element 162. That is, the LED module in the present embodiment has a configuration in which, in the configuration of the conventional example, which is illustrated in FIG. 29, the red LED element is added inside the magenta light emitting body.

The red phosphor 154 is excited by light emitted from the blue LED element 152 and emits red light. Combined light of the red light and blue light emitted from the blue LED element 152 becomes magenta light. Combined light of the magenta light and green light emitted from the green LED element 162 becomes white light. As can be seen from the above, it is possible to generate white light without providing the red LED element 156. That is, the red LED element 156 in the present embodiment functions as a light emitting element for color adjustment.

Note that, in the present embodiment, a first light emitting diode element is realized by the blue LED element 152, a second light emitting diode element is realized by the green LED element 162, and a third light emitting diode element is realized by the red LED element 156.

Moreover, the backlight driving circuit 600 in the present embodiment is configured so that each of luminance of light emitted from the blue LED element 152, luminance of light emitted from the green LED element 162, and luminance of light emitted from the red LED element 156 is able to be independently controlled for each area.

### 4.3 Adjustment of White Point

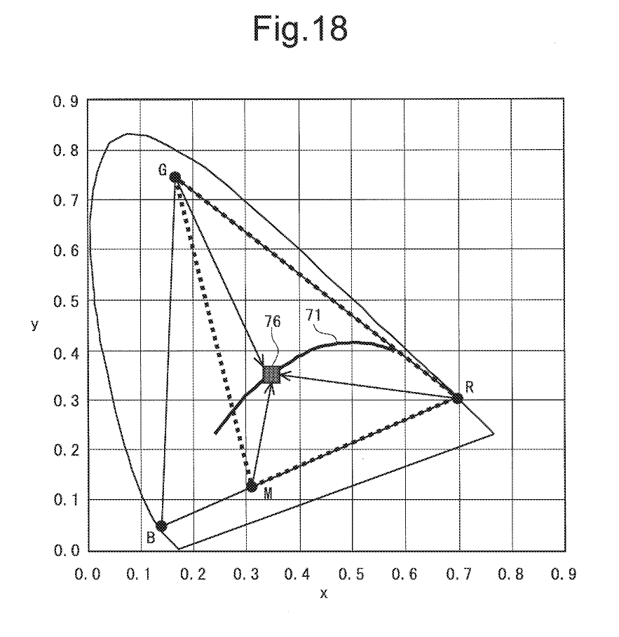

Next, adjustment of a white point will be described. In the present embodiment, (since the red phosphor 154 is excited by the light emitted from the blue LED element 152 and emits light) luminance of magenta is controlled by controlling the luminance of the light emitted from the blue LED element 152, luminance of green is controlled by controlling the luminance of the light emitted from the green LED element 162, and luminance of red is controlled by controlling the luminance of the light emitted from the red LED element 156, as illustrated in FIG. 17. That is, it is possible to independently control luminance of three colors of magenta, green, and red. Accordingly, similarly to the first embodiment, it is possible to select, as a white point, chromaticity coordinates in the range of the triangle 73 formed by connecting the chromaticity coordinates M of magenta, the chromaticity coordinates G of green, and the chromaticity coordinates R of red in an xy chromaticity diagram (refer to FIG. 6). By the way, in the present embodiment, it is possible to independently control each of the luminance of the light emitted from the blue LED element 152, the luminance of the light emitted from the green LED element 162, and the luminance of the light emitted from the red LED element 156 for each area, so that it is possible to set one white point for an entirety of the display portion 500. Specifically, for all of the areas, color temperature corresponding to predetermined chromaticity coordinates (for example, chromaticity coordinates indicated with a reference sign 76 in FIG. 18) on the blackbody locus 71 in the range of the triangle 73 formed by connecting the chromaticity coordinates M of magenta, the chromaticity coordinates G of green, and the chromaticity coordinates R of red in the xy chromaticity diagram may be selected as desired color temperature (color temperature of white when the white is displayed on the display portion 500) as illustrated in FIG. 18. In this manner, color temperature is able to be changed by adjusting luminance of the light source for each area, so that it becomes possible to suitably adjust a white point (white) regardless of variation of characteristics of the light source. In addition, for the reason similar to that of the first embodiment, it is possible to obtain a wider color reproduction range also in the present embodiment compared with the case where an LED module (the LED module having the configuration illustrated in FIG. 28) which is constituted by a red light emitting body including a red LED element, a green light emitting body including a green LED element, and a blue light emitting body including a blue LED element in order to obtain white light is adopted.

### 4.4 Effect

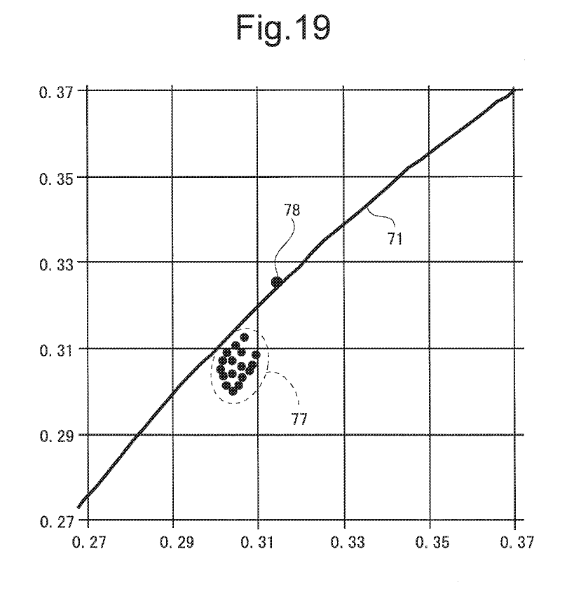

According to the present embodiment, the LED module which constitutes the backlight device 100 is constituted by the magenta light emitting body 150 including the blue LED element 152, the red phosphor (phosphor which is excited by the light emitted from the blue LED element 152 and emits red light) 154, and the red LED element 156, and the green light emitting body 160 including the green LED element 162. Magenta is generated by the light emitted from the blue LED element 152 and the light emitted from the red phosphor 154. Further, the red LED element 156 in the magenta light emitting body 150 functions as the light emitting element for color adjustment. As above, it is possible to independently control luminance of the three colors of magenta, green, and red by controlling the luminance of the light emitted from each of the LED elements. In addition, the backlight driving circuit 600 is configured so that the luminance of the light emitted from each of the LED elements is able to be controlled for each area. Accordingly, it becomes possible to adjust color temperature for each area. This makes it possible to adjust white points, which conventionally have variation between areas as indicated with a reference sign 77 in FIG. 19, so as to be one point as indicated with a reference sign 78 in FIG. 19. As a result thereof, generation of color unevenness on a screen is suppressed, and display quality is improved. Moreover, by using the red phosphor 154, the color reproduction range becomes wider compared with the case where an LED module which is constituted by a red light emitting body including a red LED element, a green light emitting body including a green LED element, and a blue light emitting body including a blue LED element is adopted. As above, according to the present embodiment, a backlight device for a liquid crystal display device, which is capable of suppressing generation of color unevenness on a screen and realizing a wide color reproduction range, is provided.

Note that, it is not always necessary to set one white point for the entirety of the display portion 500. As long as white points are adjusted in respective areas so that chromaticity coordinates of the white points become chromaticity coordinates on a blackbody locus in an xy chromaticity diagram, it is possible to display an image without causing a viewer to sense color unevenness even when the chromaticity coordinates of the white points are different between the areas.

Furthermore, also in a case where a blue LED element is used instead of the red LED element 156, it is possible to independently control luminance of three colors, so that a similar effect is able to be obtained.

### 5. Fifth Embodiment

### 5.1 Configuration

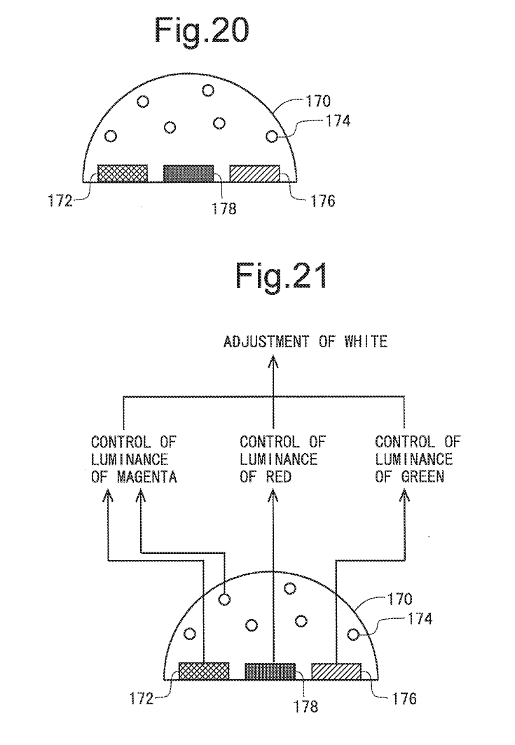

Since an entire configuration (refer to FIG. 2) and a configuration of the backlight device 100 (FIG. 3) are similar to those of the first embodiment, description thereof will be omitted. However, concerning FIG. 3, a configuration of an LED module of the present embodiment, which is to be mounted on the LED substrate 10, is different from that of the first embodiment. FIG. 20 is a view illustrating the configuration of the LED module to be mounted on the LED substrate 10 in the present embodiment. In the present embodiment, the LED module is constituted by a white light emitting body 170 in which a blue LED element 172, a red phosphor 174, a green LED element 176, and a red LED element 178 are packaged as one light emitting body. Similarly to the fourth embodiment, the backlight driving circuit 600 is configured so that luminance of light emitted from each of the LED elements is able to be controlled for each area.

The red phosphor 174 is excited by light emitted from the blue LED element 172 and emits red light. Combined light of the red light and blue light emitted from the blue LED element 172 becomes magenta light. Combined light of the magenta light and green light emitted from the green LED element 176 becomes white light. As can be seen from the above, it is possible to generate white light without providing the red LED element 178. That is, the red LED element 178 in the present embodiment functions as a light emitting element for color adjustment.

Note that, in the present embodiment, a first light emitting diode element is realized by the blue LED element 172, a second light emitting diode element is realized by the green LED element 176, and a third light emitting diode element is realized by the red LED element 178.

### 5.2 Adjustment of White Point

Next, adjustment of a white point will be described. In the present embodiment, (since the red phosphor 174 is excited by the light emitted from the blue LED element 172 and emits light) luminance of magenta is controlled by controlling luminance of the light emitted from the blue LED element 172, luminance of green is controlled by controlling luminance of light emitted from the green LED element 176, and luminance of red is controlled by controlling luminance of light emitted from the red LED element 178, as illustrated in FIG. 21. That is, it is possible to independently control luminance of three colors of magenta, green, and red. Accordingly, similarly to the first embodiment, it is possible to select, as a white point, chromaticity coordinates in the range of the triangle 73 formed by connecting the chromaticity coordinates M of magenta, the chromaticity coordinates G of green, and the chromaticity coordinates R of red in an xy chromaticity diagram (refer to FIG. 6). This makes it possible to set one white point for the entirety of the display portion 500 and to adjust the white point for each area so that chromaticity coordinates of the white point becomes chromaticity coordinates on a blackbody locus in the xy chromaticity diagram, similarly to the fourth embodiment. In addition, for the reason similar to that of the first embodiment, it is possible to obtain a wider color reproduction range also in the present embodiment compared with the case where an LED module (the LED module having the configuration illustrated in FIG. 28) which is constituted by a red light emitting body including a red LED element, a green light emitting body including a green LED element, and a blue light emitting body including a blue LED element in order to obtain white light is adopted.

### 5.3 Effect

According to the present embodiment, the LED module which constitutes the backlight device 100 is constituted by the white light emitting body 170 including the blue LED element 172, the red phosphor 174, the green LED element 176, and the red LED element 178. Magenta is generated by the light emitted from the blue LED element 172 and the light emitted from the red phosphor 174. Further, the red LED element 178 in the white light emitting body 170 functions as the light emitting element for color adjustment. As above, it is possible to independently control luminance of the three colors of magenta, green, and red by controlling the luminance of the light emitted from each of the LED elements. In addition, the backlight driving circuit 600 is configured so that the luminance of the light emitted from each of the LED elements is able to be controlled for each area. Accordingly, it becomes possible to adjust color temperature for each area. Moreover, by using the red phosphor 174, the color reproduction range becomes wider compared with the case where an LED module which is constituted by a red light emitting body including a red LED element, a green light emitting body including a green LED element, and a blue light emitting body including a blue LED element is adopted. As above, similarly to the fourth embodiment, a backlight device for a liquid crystal display device, which is capable of suppressing generation of color unevenness on a screen and realizing a wide color reproduction range, is provided.

### 6. Sixth Embodiment

### 6.1 Configuration

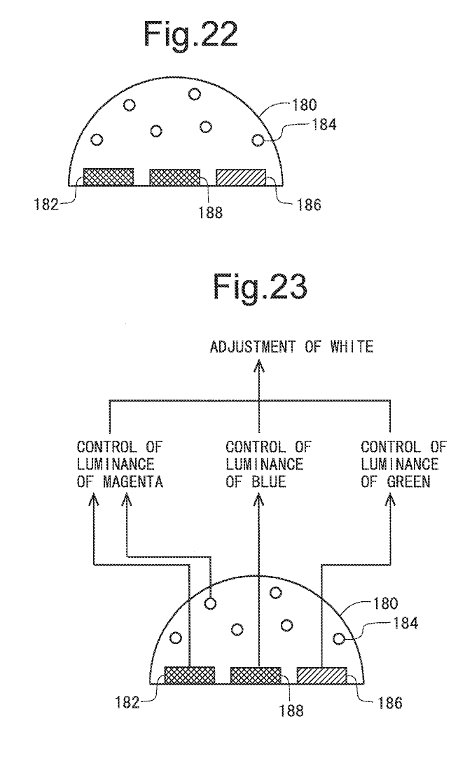

Since an entire configuration (refer to FIG. 2) and a configuration of the backlight device 100 (FIG. 3) are similar to those of the first embodiment, description thereof will be omitted. However, concerning FIG. 3, a configuration of an LED module of the present embodiment, which is to be mounted on the LED substrate 10, is different from that of the first embodiment. FIG. 22 is a view illustrating the configuration of the LED module to be mounted on the LED substrate 10 in the present embodiment. In the present embodiment, the LED module is constituted by a white light emitting body 180 in which a blue LED element 182, a red phosphor 184, a green LED element 186, and a blue LED element 188 are packaged as one light emitting body. Similarly to the fourth embodiment, the backlight driving circuit 600 is configured so that luminance of light emitted from each of the LED elements is able to be controlled for each area.

The red phosphor 184 is excited by light emitted from the blue LED element 182 and emits red light. Combined light of the red light and blue light emitted from the blue LED element 182 becomes magenta light. Combined light of the magenta light and green light emitted from the green LED element 186 becomes white light. As can be seen from the above, it is possible to generate white light without providing the blue LED element 188. That is, the blue LED element 188 in the present embodiment functions as a light emitting element for color adjustment.

Note that, in the present embodiment, a first light emitting diode element is realized by the blue LED element 182, a second light emitting diode element is realized by the green LED element 186, and a third light emitting diode element is realized by the blue LED element 188.

### 6.2 Adjustment of White Point

Next, adjustment of a white point will be described. In the present embodiment, (since the red phosphor 184 is excited by the light emitted from the blue LED element 182 and emits light) luminance of magenta is controlled by controlling luminance of the light emitted from the blue LED element 182, luminance of green is controlled by controlling luminance of light emitted from the green LED element 186, and luminance of blue is controlled by controlling luminance of light emitted from the blue LED element 188, as illustrated in FIG. 23. That is, it is possible to independently control luminance of three colors of magenta, green, and blue. Accordingly, similarly to the second embodiment, it is possible to select, as a white point, chromaticity coordinates in the range of the triangle 74 formed by connecting the chromaticity coordinates M of magenta, the chromaticity coordinates G of green, and the chromaticity coordinates B of blue in an xy chromaticity diagram (refer to FIG. 11). This makes it possible to set one white point for the entirety of the display portion 500 and to adjust the white point for each area so that chromaticity coordinates of the white point becomes chromaticity coordinates on a blackbody locus in the xy chromaticity diagram, similarly to the fourth embodiment. In addition, for the reason similar to that of the first embodiment, it is possible to obtain a wider color reproduction range also in the present embodiment compared with the case where an LED module (the LED module having the configuration illustrated in FIG. 28) which is constituted by a red light emitting body including a red LED element, a green light emitting body including a green LED element, and a blue light emitting body including a blue LED element in order to obtain white light is adopted.

### 6.3 Effect

According to the present embodiment, the LED module which constitutes the backlight device 100 is constituted by the white light emitting body 180 including the blue LED element 182, the red phosphor 184, the green LED element 186, and the blue LED element 188. Magenta is generated by the light emitted from the blue LED element 182 and the light emitted from the red phosphor 184. Further, the blue LED element 188 in the white light emitting body 180 functions as the light emitting element for color adjustment. As above, it is possible to independently control luminance of the three colors of magenta, green, and blue by controlling the luminance of the light emitted from each of the LED elements. In addition, the backlight driving circuit 600 is configured so that the luminance of the light emitted from each of the LED elements is able to be controlled for each area. Accordingly, it becomes possible to adjust color temperature for each area. Moreover, by using the red phosphor 184, the color reproduction range becomes wider compared with the case where an LED module which is constituted by a red light emitting body including a red LED element, a green light emitting body including a green LED element, and a blue light emitting body including a blue LED element is adopted. As above, similarly to the fourth embodiment, a backlight device for a liquid crystal display device, which is capable of suppressing generation of color unevenness on a screen and realizing a wide color reproduction range, is provided.

### 7. Others

### 7.1 as to Color Breaking

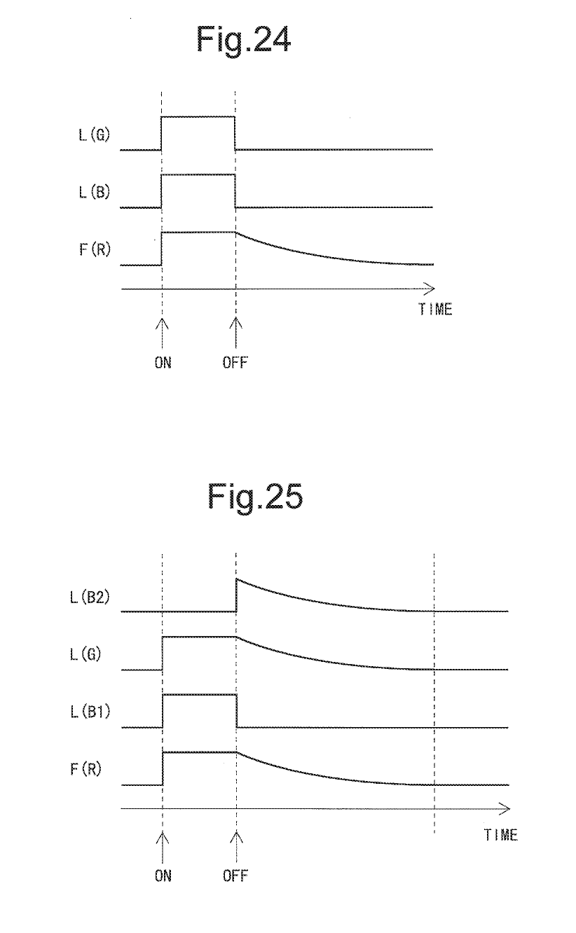

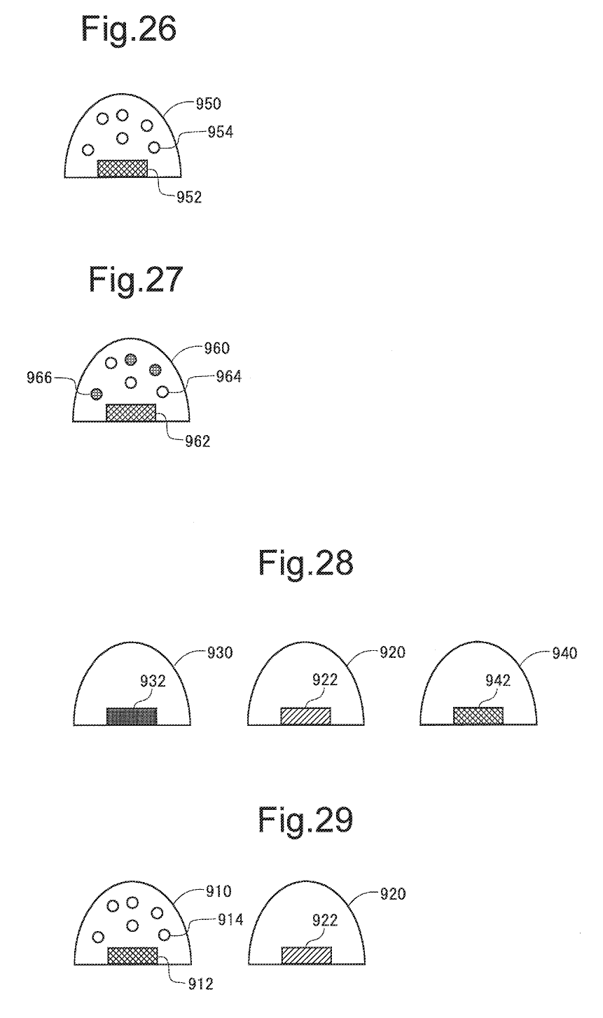

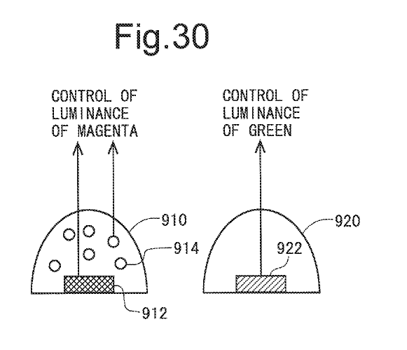

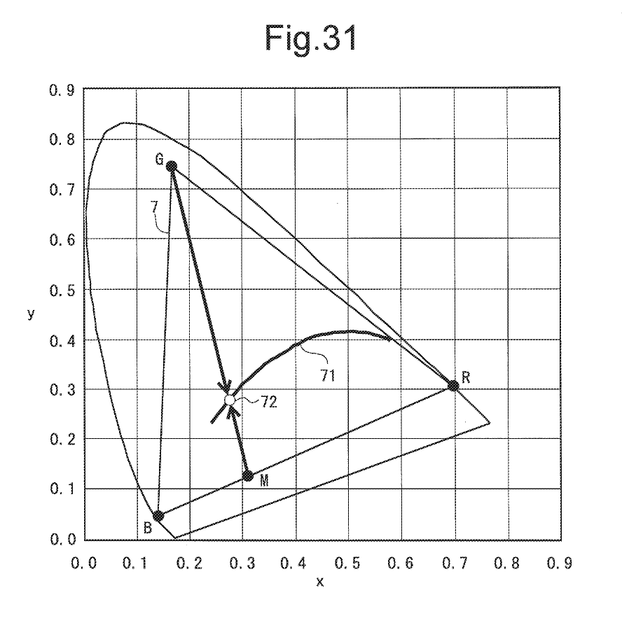

In the case where the LED module having the configuration illustrated in FIG. 29 is adopted, color breaking (color breakup) is caused by afterglow characteristics of the red phosphor 914. This will be described below. In the configuration illustrated in FIG. 29, the blue LED element 912 emits blue light, the red phosphor 914 emits red light, and the green LED element 922 emits green light. Note that, the red phosphor 914 is excited by light emitted from the blue LED element 912 and emits light. Here, when the green light emitted from the green LED element 922 is indicated with a reference sign L(G), the blue light emitted from the blue LED element 912 is indicated with a reference sign L(B), and the red light emitted from the red phosphor 914 is indicated with a reference sign F(R), change in luminance of each light is as illustrated in FIG. 24. Note that, in FIG. 24, a timing of starting supplying a lighting current to the green LED element 922 and the blue LED element 912 is represented as “on”, and a timing of cutting off the supply of the lighting current is represented as “off”.

As can be seen from FIG. 24, when the supply of the lighting current is cut off, though the green LED element 922 and the blue LED element 912 are immediately brought into a turn-off state, luminance of the red phosphor 914 is gradually reduced after the supply of the lighting current is cut off. In this manner, between the green LED element 922 and the blue LED element 912 and the red phosphor 914, there is a difference in a time until completely being brought into the turn-off state after the supply of the lighting current is cut off. Thus, along with high speed response of a liquid crystal, red color breaking is caused.

Concerning this point, according to the second embodiment, the LED module constituting the backlight device 100 includes the blue light emitting body 140 including the blue LED element 142 in addition to the components of the conventional technique illustrated in FIG. 29 (refer to FIG. 9). Accordingly, it is possible to drive the blue LED element 142 and the green LED element 122 so that change in luminance of each light is to be as illustrated in FIG. 25 when all of the light sources are turned off. Note that, in FIG. 25, the blue light emitted from the blue LED element 142 is indicated with a reference sign L(B2), the green light emitted from the green LED element 122 is indicated with the reference sign L(G), the blue light emitted from the blue LED element 112 is indicated with a reference sign L(B1), and the red light emitted from the red phosphor 114 is indicated with the reference sign F(R). As described above, by driving the blue LED element 142 and the green LED element 122, an influence of afterglow of the red phosphor 114 is cancelled by the blue light and the green light. As a result thereof, occurrence of red color breaking is suppressed.

### 7.2 as to Type of Backlight Device

Though the backlight device of the direct type is adopted in each of the embodiments, the invention is not limited thereto. The invention is applicable also in a case where a backlight device of an edge light type is adopted.

### REFERENCE SIGNS LIST

5 liquid crystal panel
10 LED substrate
12 diffusion plate
14 optical sheet
16 chassis
71 blackbody locus
100 backlight device
110, 150 magenta light emitting body
112, 142, 152, 172, 182, 188 blue LED element
114, 154, 174, 184 red phosphor
120, 160 green light emitting body
122, 162, 176, 186 green LED element
130 red light emitting body
132, 156, 178 red LED element
140 blue light emitting body
170, 180 white light emitting body
200 display control circuit
300 source driver (video signal line driving circuit)
400 gate driver (scanning signal line driving circuit)
500 display portion
600 backlight driving circuit

1. A backlight device using light emitting diode elements as a light source, the backlight device comprising:
a first light emitting body that includes a light emitting diode element and emits light at a plurality of peak wavelengths;
a second light emitting body that includes a light emitting diode element and emits light at a peak wavelength different from the plurality of peak wavelengths of the light emitted from the first light emitting body; and
a third light emitting body that includes a light emitting diode element and emits light at at least one peak wavelength among the plurality of the peak wavelengths of the light emitted from the first light emitting body, wherein
the first light emitting body, the second light emitting body, and the third light emitting body are configured such that luminance of the light emitted from the first light emitting body, luminance of the light emitted from the second light emitting body, and luminance of the light emitted from the third light emitting body are controlled independently of one another.

2. The backlight device according to claim 1, wherein
the first light emitting body includes a blue light emitting diode element and a red phosphor,
the second light emitting body includes a green light emitting diode element, and
the third light emitting body includes a red light emitting diode element.

3. The backlight device according to claim 1, wherein
the first light emitting body includes a blue light emitting diode element and a red phosphor,
the second light emitting body includes a green light emitting diode element, and
the third light emitting body includes a blue light emitting diode element.

4. The backlight device according to claim 1, further comprising a fourth light emitting body that emits light at a peak wavelength, which is different from the peak wavelength of the light emitted from the third light emitting body, among the plurality of the peak wavelengths of the light emitted from the first light emitting body.

5. The backlight device according to claim 4, wherein
the first light emitting body includes a blue light emitting diode element and a red phosphor,
the second light emitting body includes a green light emitting diode element,
the third light emitting body includes a red light emitting diode element, and
the fourth light emitting body includes a blue light emitting diode element.

6. A liquid crystal display device, comprising:
a liquid crystal panel including a display portion on which an image is displayed;
the backlight device according to claim 1, which radiates light to a rear surface of the liquid crystal panel; and
a backlight driving portion that independently controls each of the luminance of the light emitted from the first light emitting body, the luminance of the light emitted from the second light emitting body, and the luminance of the light emitted from the third light emitting body.

7. The liquid crystal display device according to claim 6, wherein, by independently controlling each of the luminance of the light emitted from the first light emitting body, the luminance of the light emitted from the second light emitting body, and the luminance of the light emitted from the third light emitting body by the backlight driving portion, a color temperature of white when the white is displayed on the display portion is able to be set to a color temperature that corresponds to certain chromaticity coordinates on a blackbody locus in a range of a triangle formed by connecting chromaticity coordinates of the light emitted from the first light emitting body, chromaticity coordinates of the light emitted from the second light emitting body, and chromaticity coordinates of the light emitted from the third light emitting body in an xy chromaticity diagram.

8. A backlight device using light emitting diode elements as a light source, the backlight device comprising:
a first light emitting diode element that emits light at a first peak wavelength,
a phosphor that is excited by the light emitted from the first light emitting diode element and emits light at a second peak wavelength,
a second light emitting diode element that emits light at a third peak wavelength, and
a third light emitting diode element that emits light at the first peak wavelength or the second peak wavelength, wherein
the first light emitting diode element, the second light emitting diode element, and the third light emitting diode element are configured such that luminance thereof are controlled independently of one another.

9. The backlight device according to claim 8, wherein the first light emitting diode element, the phosphor, and the third light emitting diode element are packaged in a light emitting body.

10. The backlight device according to claim 9, wherein
the first light emitting diode element is a blue light emitting diode element,
the phosphor is a red phosphor,
the second light emitting diode element is a green light emitting diode element, and
the third light emitting diode element is a red light emitting diode element.

11. The backlight device according to claim 8, wherein the first light emitting diode element, the phosphor, the second light emitting diode element, and the third light emitting diode element are packaged in a light emitting body.

12. The backlight device according to claim 11, wherein
the first light emitting diode element is a blue light emitting diode element,
the phosphor is a red phosphor,
the second light emitting diode element is a green light emitting diode element, and
the third light emitting diode element is a red light emitting diode element.

13. The backlight device according to claim 11, wherein
the first light emitting diode element is a blue light emitting diode element,
the phosphor is a red phosphor,
the second light emitting diode element is a green light emitting diode element, and
the third light emitting diode element is a blue light emitting diode element.

14. A liquid crystal display device, comprising:
a liquid crystal panel including a display portion on which an image is displayed;
the backlight device according to claim 8, which radiates light to a rear surface of the liquid crystal panel; and
a backlight driving portion that independently controls each of the luminance of the light emitted from the first light emitting diode element, the luminance of the light emitted from the second light emitting diode element, and the luminance of the light emitted from the third light emitting diode element.

15. The liquid crystal display device according to claim 14, wherein, by independently controlling each of the luminance of the light emitted from the first light emitting diode element, the luminance of the light emitted from the second light emitting diode element, and the luminance of the light emitted from the third light emitting diode element by the backlight driving portion, a color temperature of white when the white is displayed on the display portion is able to be set to a color temperature that corresponds to certain chromaticity coordinates on a blackbody locus in a range of a triangle formed by connecting chromaticity coordinates of combined light of the light emitted from the first light emitting diode element and the light emitted from the phosphor, chromaticity coordinates of the light emitted from the second light emitting diode element, and chromaticity coordinates of the light emitted from the third light emitting diode element in an xy chromaticity diagram.

16. The liquid crystal display device according to claim 15, wherein
the display portion is logically divided into a plurality of areas, and
the backlight driving portion controls, for each of the areas, the luminance of the light emitted from the first light emitting diode element, the luminance of the light emitted from the second light emitting diode element, and the luminance of the light emitted from the third light emitting diode element.
